(19) United States
(12) Patent Application Publication
(10) Pub. No.: US 2024/0328477 A1
(43) Pub. Date: Oct. 3, 2024

(54) Shock Absorber with Variable Damping

(71) Applicant: Shu-Lin Kuo, Taichung City (TW)

(72) Inventor: Shu-Lin Kuo, Taichung City (TW)

(21) Appl. No.: 18/359,539

(22) Filed: Jul. 26, 2023

(30) Foreign Application Priority Data
Mar. 31, 2023 (TW) 112203061

(51) Int. Cl. F16F 7/08; F16F 7/09

(52) U.S. Cl. CPC F16F 7/082; F16F 7/09; F16F 2222/12; F16F 2224/04; F16F 2232/08; F16F 2234/02; F16F 2238/026; F16F 2238/04

(57) ABSTRACT

The present invention relates to a shock absorber structure with variable damping, comprising an outer tube, a piston, a shaft, a plurality of spring sets, a cushioning piston cover set, an inlet regulating bolt, and a damping regulating bolt, wherein the outer tube is filled with damping oil. The shaft drives the piston by moving to the upper dead center to produce a primary damping of cushioning, and the cushioning piston cover set and the inlet regulating bolt produce a secondary damping of cushioning to achieve the effect of variable damping. When the shaft reaches the lower dead center, the spring set rebounds and pushes the cushioning piston cover set and the piston for displacement to achieve the cushioning state with variable damping and improve the overall shock absorption and cushioning effect.

### FIELD OF INVENTION

The present invention is a shock absorber structure with variable damping, in particular a shock absorber structure with variable damping used in the field of technology to which it belongs.

### BACKGROUND OF THE INVENTION

According to a shock absorber of prior art, a cross-section of the shock absorber is shown in FIG. 6, comprising an outer tube 10, a piston 20, and a shaft 30, wherein a tube cover 11 is provided on both sides of the outer tube 10, and a perforated hole 110 is provided on one side of the tube cover 11, and a damping chamber 100 is provided inside the outer tube 10, within damping oil is filled in the damping chamber 100. An inlet regulating bolt 35 is provided inside the shaft 30, wherein the piston 20 is fixed to one end of the shaft 30 and slidably disposed inside the outer tube 10, and the shaft 30 is slidably threaded through the perforated hole 110 in the tube cover 11. By the pressure applied to the shaft 30, the piston 20 in the outer tube 10 is cushioned against the damping oil in the damping chamber 100 to form a cushioning drop, while the damping can be adjusted by the inlet regulating bolt 35. Although it can achieve the effect of shock absorption, the repeated operation of the damping oil in the damping chamber 100 of the outer tube 10 will cause heat degradation of the damping oil due to compression and mixing of micro-bubbles, resulting in a reduction of the consistency of the damping oil becomes thinner, which in turn affects the effectiveness of cushioning, and therefore there is a need for improvement.

### SUMMARY OF THE INVENTION

Given the problems of structural stability and poor functionality of the conventional shock absorber structure, the present invention has been developed as a shock absorber structure with variable damping.

The main purpose of the present invention is to provide a shock absorber structure with variable damping, comprising an outer tube, a piston, and a shaft, wherein a tube cover is provided on both sides of the outer tube, and a perforated hole is provided on one side of the tube cover; a damping chamber is provided inside the outer tube with damping oil in the damping chamber; the piston is fixed to the shaft and is slidably provided inside the outer tube, and the shaft is slidably threaded through the perforated hole of the tube cover and is characterized in that: the shaft is provided with an axial oil passage and at least one lateral oil passage communicating with each other, and the two side ends of the axial oil passage are provided with a first screwing part and a second screwing part inwardly. The piston is provided with a plurality of longitudinal oil guiding passages, and is further provided with a spring set, a cushioning piston cover set, an inlet regulating bolt, and a damping regulating bolt, wherein the spring set is provided with a cushioning spring and an auxiliary spring, and the cushioning piston cover set is provided with a piston fitting chamber seat and a piston fitting cover, the piston fitting chamber seat is provided with a perforated hole on a closed side and equipped with several oil guiding holes on the side near the top edge, and the piston fitting cover is provided with a holding ring, and the piston fitting chamber seat is slidably sleeved with the piston fitting cover to enable the piston fitting cover to close and open the oil guiding holes provided by the piston fitting chamber seat; a plurality of lateral oil inlet ports and a central oil passage are provided by the inlet regulating bolt, and those lateral oil inlet ports and the central oil passage are communicated. The perforated hole of the piston fitting chamber seat corresponds to the first screwing part of the shaft near the axial oil passage, the inlet regulating bolt is threaded through the perforated hole of the piston fitting chamber seat and screwed to the first screwing part of the shaft, the cushioning piston cover set and the spring set are accommodated in the damping chamber of the outer tube, and the cushioning spring of the spring set is placed against the lower edge of the holding ring of the piston fitting cover on one side, and the auxiliary spring is placed against the upper edge of the holding ring of the piston fitting cover on one side and the other side is placed against the bottom of the piston, the damping regulating bolt is adjustable by screwing and securing to the second screwing part of the axial oil passage of the shaft; with the shaft of driving the piston by moving to the upper dead center, so that the damping oil flows in the damping chamber of the outer tube in correspondence with the pressed piston and the plurality of oil guiding passages therein; meanwhile, the damping oil is supplied into the plurality of lateral oil inlet ports of the inlet regulating bolt so that the damping oil enters the central oil passage and then is supplied into the central oil passage of the shaft and is discharged from the lateral oil passage to perform the primary damping of the cushioning; meanwhile, the cushioning spring of the spring set is pressed down by the piston fitting cover, and when the cushioning spring contacts the bottom of the damping chamber of the outer tube, it causes the piston fitting chamber seat to slide relative to the piston fitting cover, while the oil guiding holes provided by the piston fitting chamber seat are covered by the piston fitting cover, and is stopped to discharge the damping oil so as to perform the secondary damping of the cushioning, to achieve the effect of variable damping. When the shaft reaches the lower dead center, the cushioning spring of the spring set rebounds and pushes the piston fitting cover of the cushioning piston cover set, simultaneously, the auxiliary spring pushes the piston fitting cover and the piston to perform a relative displacement action.

In a preferred embodiment, the damping regulating bolt is adjustable by screwing and securing to the second screwing part of the axial oil passage of the shaft. Adjusting the damping regulating bolt so that it can be displaced within the axial oil passage of the shaft to open for conduction or close for blocking the relative lateral oil passage, to control whether or not the axial oil passage of the shaft is supplied with damping oil, and to adjust the softness and hardness of the elasticity of the shock absorber, thereby enhancing the multi-function practicability of the present invention.

In a preferred embodiment, a locking thread section is provided on the end side of the shaft, and a retaining ring having a locking internal thread is provided. After the end side of the shaft is threaded through the perforated hole of the piston fitting chamber seat, the locking internal thread of the retaining ring is screwed into the locking thread section of the shaft, and the retaining ring presses against the inside of the perforated hole of the piston fitting chamber seat, thereby improving the ease of structural assembly, and increasing the multi-practicability of the present invention.

In a preferred embodiment, a convex ring is encircled on the outer periphery of the piston fitting chamber seat, and a stopping inner edge is provided on the inner side of the piston fitting cover, so that when the piston fitting chamber seat and the piston fitting cover slide together, the convex ring provided by the piston fitting chamber seat is restricted and stopped relative to the stopping inner edge of the piston fitting cover, thereby enhancing the stability of the inter-structural action and increasing the multi-practicality of the present invention.

By combining an outer tube, a piston, a shaft, a plurality of spring sets, a cushioning piston cover set, an inlet regulating bolt, and a damping regulating bolt, wherein the outer tube is filled with damping oil, and the shaft drives the piston by moving to the upper dead center to make the damping oil in the outer tube to produce the primary damping of the cushioning relative to the downwardly pressed piston, and to produce the secondary damping of the cushioning with the cushioning piston cover set and the inlet regulating bolt to achieve an effectiveness of the variable damping. When the shaft reaches the lower dead center, the spring set rebounds to push the cushioning piston cover set and the piston for displacement action to make the cushioning state with damping variability, thereby improving the overall effect of shock absorption and cushioning and achieving the effect of structural functionality and cushioning stabilization.

### BRIEF DESCRIPTION OF THE DRAWINGS

FIG. 1 is a schematic diagram of the three-dimensional assembly state of the shock absorber structure with variable damping of the present invention;

FIG. 2 is a schematic diagram of the three-dimensional disassembly state of the shock absorber structure with variable damping of the present invention;

FIG. 3 is a cross-sectional side view reference diagram of the shock absorber structure with variable damping of the present invention;

FIG. 4 is a cross-sectional side view reference diagram of the shock absorber structure with variable damping of the present invention with primary damping of the cushioning action state;

FIG. 5 is a cross-sectional side view reference diagram of the shock absorber structure with variable damping of the present invention with secondary damping of the cushioning action state; and

FIG. 6 is a cross-sectional view reference diagram of the shock absorber of the prior art in the action state.

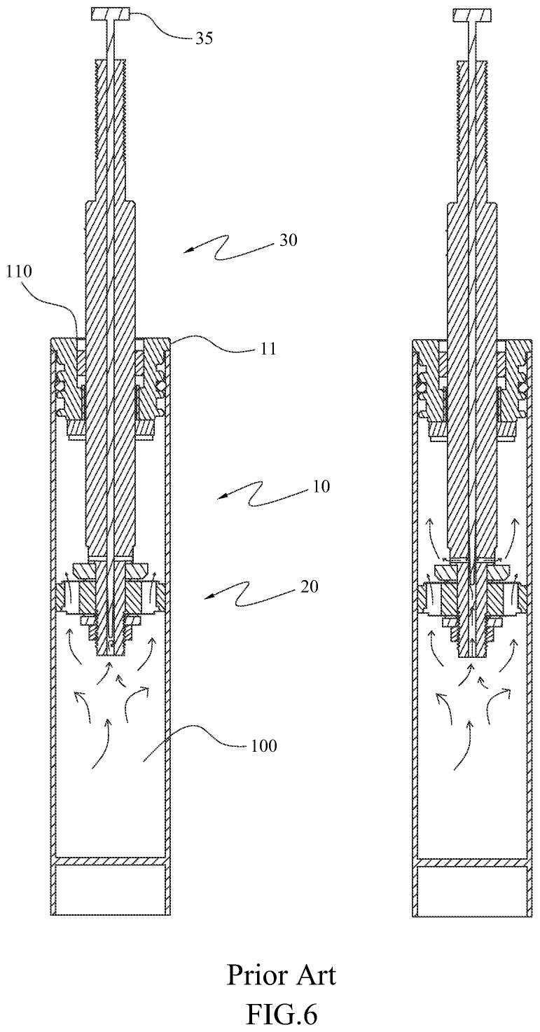

### DETAILED DESCRIPTION OF THE PREFERRED EMBODIMENTS

For a better understanding of the structure, features, and other purposes of the present invention, the following preferred embodiments will be illustrated in detail with drawings, but the embodiments illustrated herein are for illustrative purposes only and are not intended to be the sole limitations of the patent application.

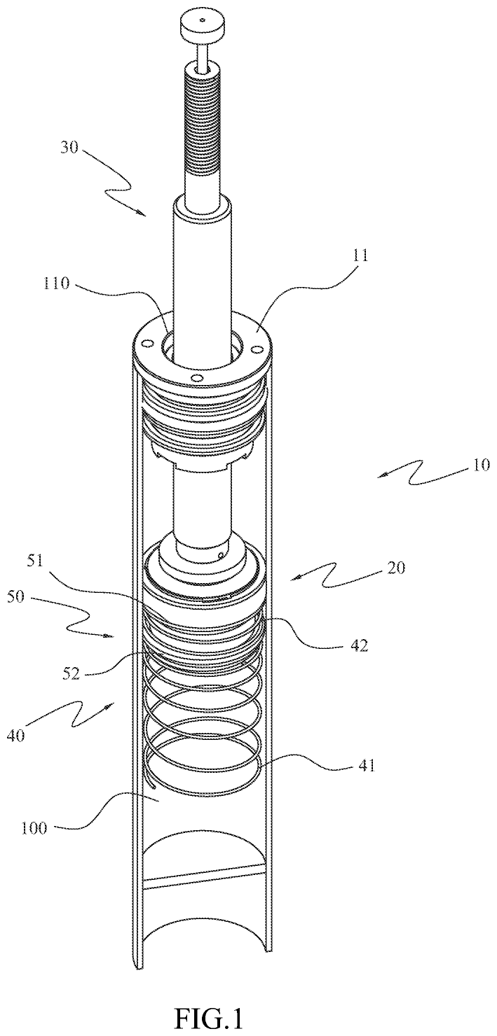

Please refer to FIGS. 1 to 3, which are the three-dimensional assembly state, three-dimensional disassembly state, and cross-sectional side view reference diagrams of the shock absorber structure with variable damping of the present invention, which comprises: an outer tube 10, a piston 20, and a shaft 30, wherein a tube cover 11 is provided on both sides of the outer tube 10, and a perforated hole 110 is provided on one side of the tube cover 11; a damping chamber 100 is provided inside the outer tube 10 with damping oil in the damping chamber 100; the piston 20 is fixed to the shaft 30, which is slidably provided inside the outer tube 10, and the shaft 30 is slidably threaded through the perforated hole 110 of the tube cover 10 and is characterized in that: the shaft 30 is provided with an axial oil passage 31 and at least one lateral oil passage 32 communicating with each other, and the two side ends of the axial oil passage 31 are provided with a first screwing part 310 and a second screwing part 320 inwardly. The piston 20 is provided with a plurality of longitudinal oil guiding passages 21, and is further provided with a spring set 40, a cushioning piston cover set 50, an inlet regulating bolt 60, and a damping regulating bolt 70, wherein the spring set 40 is provided with a cushioning spring 41 and an auxiliary spring 42, and the cushioning piston cover set 50 is provided with a piston fitting chamber seat 51 and a piston fitting cover 52, the piston fitting chamber seat 51 is provided with a perforated hole on a closed side and equipped with several oil guiding holes 511 on the side near the top edge, and the piston fitting cover 52 is provided with a holding ring 520, and the piston fitting chamber seat 51 is slidably sleeved with the piston fitting cover 52 to enable the piston fitting cover 52 to close and open the oil guiding holes 511 provided by the piston fitting chamber seat 51; a plurality of lateral oil inlet ports 601 and a central oil passage 602 are provided by the inlet regulating bolt 60, and those lateral oil inlet ports 601 and the central oil passage 602 are communicated. The perforated hole 510 of the piston fitting chamber seat 51 corresponds to the first screwing part 310 of the shaft 30 near the axial oil passage 31, the inlet regulating bolt 60 is threaded through the perforated hole 510 of the piston fitting chamber seat 51 and screwed to the first screwing part 310 of the shaft 30, the cushioning piston cover set 50 and the spring set 40 are accommodated in the damping chamber 100 of the outer tube 10, and the cushioning spring 41 of the spring set 40 is placed against the lower edge of the holding ring 520 of the piston fitting cover 52 on one side, and the auxiliary spring 42 is placed against the upper edge of the holding ring 520 of the piston fitting cover 52 on one side and the other side is placed against the bottom of the piston 20, the damping regulating bolt 70 is adjustable by screwing and securing to the second screwing part 311 of the axial oil passage 31 of the shaft 30.

The shock absorber structure with variable damping of the present invention is accomplished by combining the above structures.

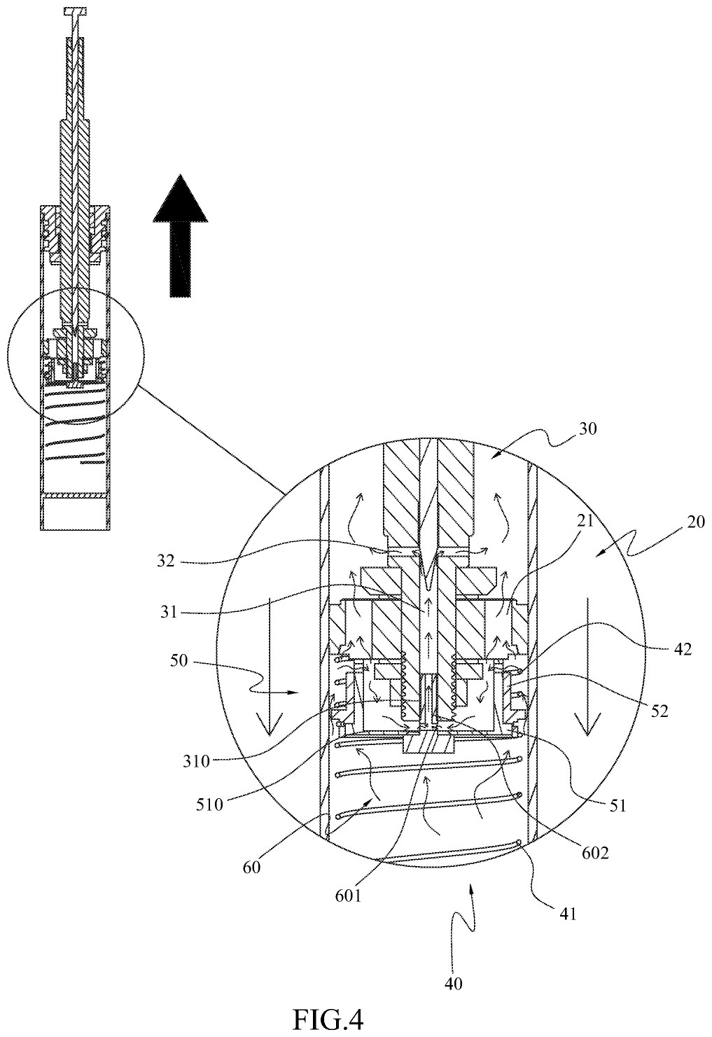

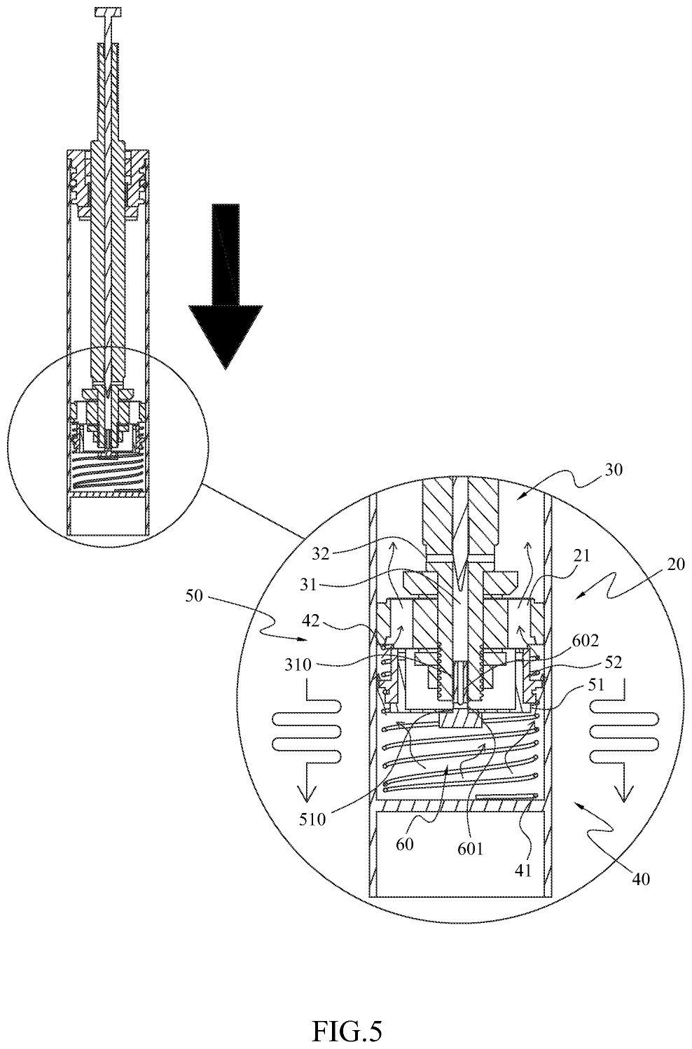

Referring to FIGS. 1 to 5, which are the three-dimensional assembly state, the three-dimensional disassembly state, the cross-sectional side view state, the cross-sectional side view primary damping state of the cushioning action, and the cross-sectional side view secondary damping state of the cushioning action, the reference diagrams of the shock absorber structure with variable damping of the present invention. The perforated hole 510 of the piston fitting chamber seat 51 corresponds to the first screwing part 310 of the shaft 30 near the axial oil passage 31, the inlet regulating bolt 60 is threaded through the perforated hole 510 of the piston fitting chamber seat 51 and screwed to the first screwing part 310 of the shaft 30, the cushioning piston cover set 50 and the spring set 40 are accommodated in the damping chamber 100 of the outer tube 10, and the cushioning spring 41 of the spring set 40 is placed against the lower edge of the holding ring 520 of the piston fitting cover 52 on one side, and the auxiliary spring 42 is placed against the upper edge of the holding ring 520 of the piston fitting cover 52 on one side and the other side is placed against the bottom of the piston 20, the highest and lowest points of the shaft 30 relatives to the rise and fall in the damping chamber 100 of the outer tube 10 are referred to as the upper dead center and the lower dead center. With the shaft 30 of driving the piston 20 by moving to the upper dead center, so that the damping oil flows in the damping chamber 100 of the outer tube 10 in correspondence with the pressed piston 20 and the plurality of oil guiding passages 21 therein; meanwhile, the damping oil is supplied into the plurality of lateral oil inlet ports 601 of the inlet regulating bolt 60 so that the damping oil enters the central oil passage 602 and then is supplied into the central oil passage 602 of the shaft 30 and is discharged from the lateral oil passage 32 to perform the primary damping of the cushioning; meanwhile, the cushioning spring 41 of the spring set 40 is pressed down by the piston fitting cover 52, and when the cushioning spring 41 contacts the bottom of the damping chamber 100 of the outer tube 10, it causes the piston fitting chamber seat 51 to slide relative to the piston fitting cover 52, while the oil guiding holes 511 provided by the piston fitting chamber seat 51 are covered by the piston fitting cover 52, and is stopped to discharge the damping oil so as to perform the secondary damping of the cushioning, to achieve the effect of variable damping. When the shaft 30 reaches the lower dead center, the cushioning spring 41 of the spring set 40 rebounds and pushes the piston fitting cover 52 of the cushioning piston cover set 50, simultaneously, the auxiliary spring 42 pushes the piston fitting cover 52 and the piston 20 to perform a relative displacement action to achieve the cushioning state with variable damping; and the damping regulating bolt 70 can be adjusted relative to the second screwing part 311 provided in the axial oil passage 31 of the shaft 30, thereby improving the overall shock absorbing and cushioning effect, to achieve the effects of structural functionality and stability of the cushioning effect.

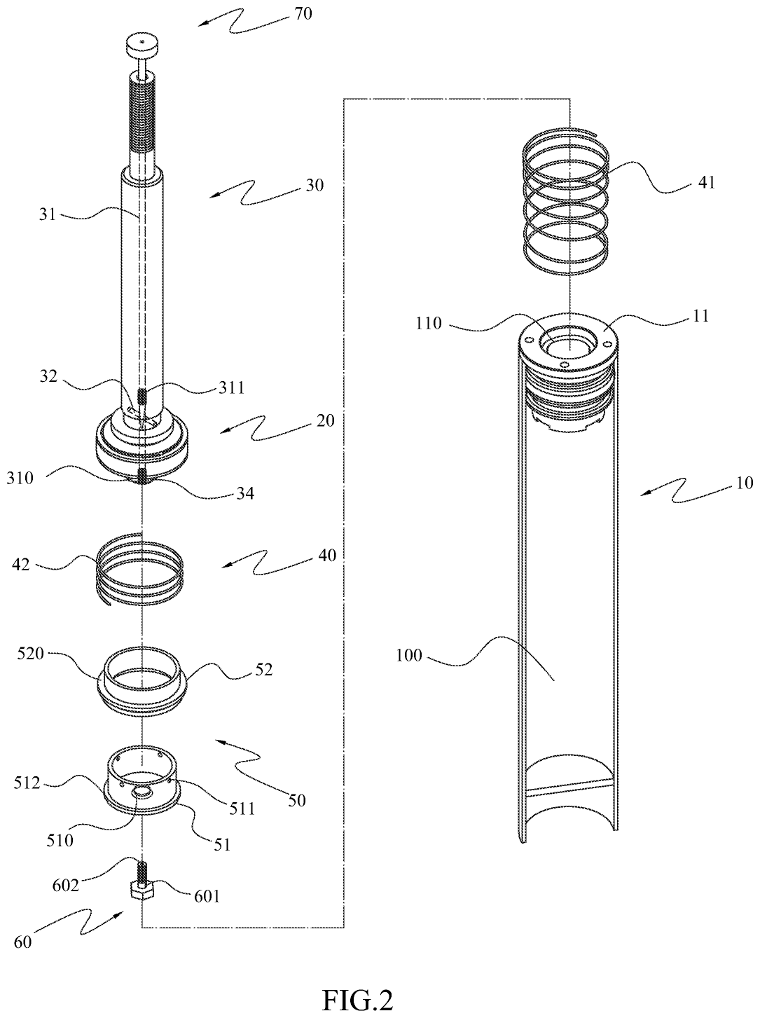

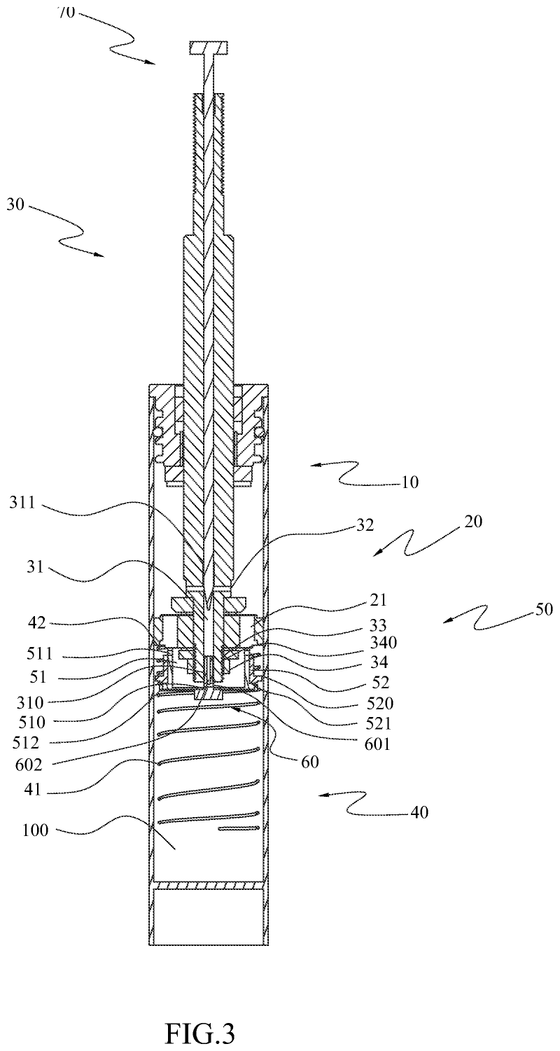

Referring to FIGS. 2 and 3, which are the three-dimensional disassembled and cross-sectional side view reference diagrams of the shock absorber structure with variable damping of the present invention. In a preferred embodiment, the damping regulating bolt 70 is adjustable by screwing and securing to the second screwing part 311 of the axial oil passage 31 of the shaft 30. By adjusting the damping regulating bolt 70 so that it can be displaced within the axial oil passage 31 of the shaft 30 to open for conduction or close for blocking the relative lateral oil passage 32, to control whether or not the axial oil passage 31 of the shaft 30 is supplied with damping oil, and to adjust the softness and hardness of the elasticity of the shock absorber, the multi-function practicability of the present invention is enhanced.

Referring to FIGS. 2 and 3, which are three-dimensional disassembled and cross-sectional side view reference diagrams of the shock absorber structure with variable damping of the present invention. In a preferred embodiment, a locking thread section 33 is provided on the end side of the shaft 30, and a retaining ring 34 having a locking internal thread 340 is provided. After the end side of the shaft 30 is threaded through the perforated hole 510 of the piston fitting chamber seat 51, the locking internal thread 340 of the retaining ring 34 is screwed into the locking thread section 33 of the shaft 30, and the retaining ring 34 presses against the inside of the perforated hole 510 of the piston fitting chamber seat 51, thereby improving the ease of structural assembly, and increasing the multi-practicability of the present invention.

Referring to FIGS. 2 and 3, which are three-dimensional disassembled and cross-sectional side view reference diagrams of the shock absorber structure with variable damping of the present invention. In a preferred embodiment, a convex ring 512 is encircled on the outer periphery of the perforated hole 510 of the piston fitting chamber seat 51, and a stopping inner edge 521 is provided on the inner side of the piston fitting cover 52, so that when the piston fitting chamber seat 51 and the piston fitting cover 52 slide together, the convex ring 512 provided by the piston fitting chamber seat 51 is restricted and stopped relative to the stopping inner edge 521 of the piston fitting cover 52, thereby enhancing the stability of the inter-structural action and increasing the multi-practicality of the present invention.

In summary, the present invention fulfills the above functions and purposes, therefore the present invention meets the requirements for a patent application, and I hereby apply in accordance with the law. What is claimed is:

1 A shock absorber structure with variable damping, comprising an outer tube, a piston, and a shaft, wherein a tube cover is provided on both sides of the outer tube, and a perforated hole is provided on one side of the tube cover; a damping chamber is provided inside the outer tube with damping oil in the damping chamber; the piston is fixed to the shaft and is slidably provided inside the outer tube, and the shaft is slidably threaded through the perforated hole of the tube cover, and is characterized in that: the shaft is provided with an axial oil passage and at least one lateral oil passage communicating with each other, and the two side ends of the axial oil passage are provided with a first screwing part and a second screwing part inwardly; the piston is provided with a plurality of longitudinal oil guiding passages, and is further provided with a spring set, a cushioning piston cover set, an inlet regulating bolt, and a damping regulating bolt, wherein the spring set is provided with a cushioning spring and an auxiliary spring, and the cushioning piston cover set is provided with a piston fitting chamber seat and a piston fitting cover, the piston fitting chamber seat is provided with a perforated hole on a closed side and equipped with several oil guiding holes on the side near the top edge, and the piston fitting cover is provided with a holding ring, and the piston fitting chamber seat is slidably sleeved with the piston fitting cover to enable the piston fitting cover to close and open the oil guiding holes provided by the piston fitting chamber seat; a plurality of lateral oil inlet ports and a central oil passage are provided by the inlet regulating bolt, and those lateral oil inlet ports and the central oil passage are communicated; the perforated hole of the piston fitting chamber seat corresponds to the first screwing part of the shaft near the axial oil passage, the inlet regulating bolt is threaded through the perforated hole of the piston fitting chamber seat and screwed to the first screwing part of the shaft, the cushioning piston cover set and the spring set are accommodated in the damping chamber of the outer tube, and the cushioning spring of the spring set is placed against the lower edge of the holding ring of the piston fitting cover on one side, and the auxiliary spring is placed against the upper edge of the holding ring of the piston fitting cover on one side and the other side is placed against the bottom of the piston, the damping regulating bolt is adjustable by screwing and securing to the second screwing part of the axial oil passage of the shaft.

2. The shock absorber structure with variable damping according to claim 1, wherein, a locking thread section is provided on the end side of the shaft and a locking internal thread is provided in the perforated hole of the piston fitting chamber seat, wherein the locking internal thread in the perforated hole of the piston fitting chamber seat and the locking thread section of the shaft are locked and fixed to each other.

3. The shock absorber structure with variable damping according to claim 1, wherein, the damping regulating bolt is adjustable by screwing and securing to the second screwing part of the axial oil passage of the shaft; by adjusting the damping regulating bolt so that it can be displaced within the axial oil passage of the shaft to open for conduction or close for blocking the relative lateral oil passage, to control whether or not the axial oil passage of the shaft is supplied with damping oil, and to adjust the softness and hardness of the elasticity of the shock absorber.

4. The shock absorber structure with variable damping according to claim 3, wherein, a locking thread section is provided on the end side of the shaft, and a retaining ring having a locking internal thread is provided; after the end side of the shaft is threaded through the perforated hole of the piston fitting chamber seat, the locking internal thread of the retaining ring is screwed into the locking thread section of the shaft, and the retaining ring presses against the inside of the perforated hole of the piston fitting chamber seat.

5. The shock absorber structure with variable damping according to claim 1, wherein, a convex ring is encircled on the outer periphery of the piston fitting chamber seat, and a stopping inner edge is provided on the inner side of the piston fitting cover, so that when the piston fitting chamber seat and the piston fitting cover slide together, the convex ring provided by the piston fitting chamber seat is restricted and stopped relative to the stopping inner edge of the piston fitting cover.

6. The shock absorber structure with variable damping according to any one of claims 1 to 5, wherein, with the shaft of driving the piston by moving to the upper dead center, so that the damping oil flows in the damping chamber of the outer tube in correspondence with the pressed piston and the plurality of oil guiding passages therein; meanwhile, the damping oil is supplied into the plurality of lateral oil inlet ports of the inlet regulating bolt so that the damping oil enters the central oil passage and then is supplied into the central oil passage of the shaft and is discharged from the lateral oil passage to perform a primary damping of the cushioning; meanwhile, the cushioning spring of the spring set is pressed down by the piston fitting cover, and when the cushioning spring contacts the bottom of the damping chamber of the outer tube, it causes the piston fitting chamber seat to slide relative to the piston fitting cover, while the oil guiding holes provided by the piston fitting chamber seat are covered by the piston fitting cover, and is stopped to discharge the damping oil so as to perform a secondary damping of the cushioning, to achieve the effect of variable damping; when the shaft reaches the lower dead center, the cushioning spring of the spring set rebounds and pushes the piston fitting cover of the cushioning piston cover set, simultaneously, the auxiliary spring pushes the piston fitting cover and the piston to perform a relative displacement action to achieve the cushioning state with variable damping; and the damping regulating bolt can be adjusted relative to the second screwing part provided in the axial oil passage of the shaft.
